(19) United States
(12) Patent Application Publication
(10) Pub. No.: US 2026/0239212 A1
(43) Pub. Date: Aug. 13, 2026

(54) METHOD AND APPARATUS FOR COMMUNICATION IN WIRELESS COMMUNICATION SYSTEM

(71) Applicant: Samsung Electronics Co., Ltd., Suwon-si, Gyeonggi-do (KR)

(72) Inventors: Pengru LI, Beijing (CN); Feifei SUN, Beijing (CN)

(21) Appl. No.: 19/160,701

(22) PCT Filed: Feb. 29, 2024
(86) PCT No.: PCT/KR2024/002637

§ 371 Date: Aug. 28, 2025

(30) Foreign Application Priority Data
Mar. 1, 2023 (CN) 202310200068.3

(51) Int. Cl. H04W 52/02; H04W 72/23; H04W 76/28

(52) U.S. Cl. CPC H04W 52/0235; H04W 72/23; H04W 76/28

(57) ABSTRACT

The disclosure relates to a 5G or 6G communication system for supporting a higher data transmission rate. The present disclosure provides a node and a user equipment in a wireless communication system and methods performed by the same. A method performed by a user equipment (UE) in a wireless communication system provided by the present disclosure includes: receiving a first signal, wherein the first signal includes a trigger signal for triggering the UE to perform reporting or a signal for power supply; and reporting second information or receiving a second signal for power supply based on energy of the first signal and/or power of the UE.

### CROSS-REFERENCE TO RELATED APPLICATION(S)

This application is a U.S. National Stage application under 35 U.S.C. §371 of an International application number PCT/KR 2024/002637, filed on Feb. 29, 2024, which is based on and claims priority of a Chinese patent application number 202310200068.3, filed on Mar. 1, 2023, in the Korean Intellectual Property Office, the disclosure of which is incorporated by reference herein in its entirety.

### TECHNICAL FIELD

The present disclosure relates to the technical field of wireless communication, and more specifically, it relates to a node, user equipment in a wireless communication system and a method thereof.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

In 5G systems, hybrid FSK and QAM modulation (FQAM) and sliding window superposition coding (SWSC) as advanced coding modulation (ACM), and filter bank multicarrier (FBMC), non-orthogonal multiple access (NOMA) and sparse code multiple access (SCMA) as advanced access technologies have been developed.

### DISCLOSURE OF INVENTION

### Technical Problem Solution to Problem

Embodiments of the present disclosure provides a method performed by a user equipment (UE) in a wireless communication system, which includes: receiving a first signal, wherein the first signal includes a trigger signal for triggering the UE to perform reporting or a signal for power supply, and reporting second information or receiving a second signal for power supply based on energy of the first signal and/or power of the UE.

According to embodiments of the present disclosure, reporting second information or receiving a second signal for power supply based on energy of the first signal and/or power of the UE includes: when the energy of the first signal meets a first condition and/or the power of the UE meets a second condition, reporting the second information; and/or when the energy of the first signal does not meet the first condition and/or the power of the UE does not meet the second condition, receiving the second signal for power supply; wherein the first condition includes that the energy of the first signal is greater than a first threshold; the second condition includes that the power of the UE is greater than a second threshold.

According to embodiments of the present disclosure, wherein the second information includes at least one of: identification (ID) of the UE and/or a UE group, power information of the UE, data of the UE and measurement results.

According to embodiments of the present disclosure, the method further includes receiving configuration information of the first signal, wherein the configuration information of the first signal includes at least one of the following: subcarrier spacing of the first signal, starting physical resource block (PRB) index of the first signal, number of occupied PRBs of the first signal, port of the first signal, transmission period and/or offset of the first signal, and time-domain starting point and/or duration of the first signal.

According to embodiments of the present disclosure, receiving the configuration information of the first signal includes at least one of: obtaining the configuration information of the first signal by receiving a radio resource control (RRC) message or a media access control (MAC) control element (CE) message; obtaining the configuration information of the first signal by receiving downlink control information (DCI).

According to embodiments of the present disclosure, receiving a first signal includes monitoring and/or receiving the first signal based on the configuration information, wherein monitoring and/or receiving the first signal based on the configuration information includes at least one of: monitoring and/or receiving the first signal on a configured transmission resource for the first signal activated by downlink control information (DCI); monitoring and/or receiving the first signal at a physical downlink shared channel (PDSCH) occasion; periodically monitoring and/or receiving the first signal on a configured transmission resource for the first signal; monitoring and/or receiving a first signal indicated by downlink control information (DCI); monitoring and/or receiving the first signal in a number of predefined time units before data reporting; monitoring and/or receiving the first signal within a configured first window.

According to embodiments of the present disclosure, configuration of the first window includes at least one of: receiving first information of the configured first window from a node; obtaining first information of the first window by receiving a radio resource control (RRC) message or a media access control (MAC) control element (CE) message; wherein the first information includes at least one of the following: a period of the first window, a starting location of the first window, a duration of the first window and a bandwidth of the first window, wherein the starting location of the first window is a starting time unit of the first window.

According to embodiments of the present disclosure, the period of the first window is configured according to at least one of the following: configuring the period of the first window according to a period of a discontinuous reception active state; configuring the period of the first window according to a period of a paging occasion (PO); configuring the period of the first window by a core network.

According to embodiments of the present disclosure, when the energy of the first signal does not meet the first condition and/or the power of the UE does not meet the second condition, receiving the second signal for power supply includes performing at least one of the following: receiving the second signal during a discontinuous reception (DRX) active state; starting a first timer, monitoring a physical downlink control channel (PDCCH) scheduling the second signal during a DRX active state, and/or not starting a DRX inactive timer; starting a first timer, monitoring a physical downlink control channel (PDCCH) scheduling the second signal during a DRX active state, and/or not monitoring or receiving a PDCCH scheduling for other signals except the second signal and/or a wake-up signal.

According to embodiments of the present disclosure, the method further includes: when the energy of the first signal does not meet the first condition and/or the power of the UE does not meet the second condition, transmitting a negative acknowledgement (NACK) signal or a new uplink control information (UCI) format to a node.

According to embodiments of the present disclosure, the method further includes: transmitting UE capability to a node; and receiving configuration information of the second signal from the node, wherein the configuration information of the second signal is determined by the node based on the UE capability.

According to embodiments of the present disclosure, the method further includes: transmitting a data size to be reported to the node; and receiving configuration information of the second signal from the node, wherein the configuration information of the second signal is determined by the node based on the data size to be reported.

According to embodiments of the present disclosure, reporting the second information includes performing at least one of the following: obtaining time-frequency resources for data reporting by receiving a radio resource control (RRC) message or a media access control (MAC) control element (CE) message, and reporting the second information on the time-frequency resources; reporting the second information on time-Substitute frequency resources indicated by time domain resource assignment (TDRA) and/or frequency domain resource assignment (FDRA)in received downlink control information (DCI) format 0_0 or DCI format 0_1 or DCI format 0_2; reporting the second information using a scheduled physical uplink shared channel (PUSCH) on time-frequency resources indicated by TDRA and/or FDRA in DCI format 0_0 and/or DCI format 0_1 and/or DCI format 0_2; periodically reporting the second information on configured time-frequency resources; when the UE obtains the configuration information of the first signal by receiving DCI format 1_0 and/or DCI format 1_1 and/or DCI format 1_2, reporting the second information using a physical uplink control channel (PUCCH) associated with the DCI; after receiving the first signal, reporting the second information through the first grant-free PUSCH or in the next data reporting period; after receiving the first signal, reporting the second information once or periodically within a predefined time period; receiving downlink scheduling grant information to trigger the UE to report the second information once or periodically on a PUSCH; when the UE detects the first signal at a transmitted PDSCH occasion, reporting the second information on a PUCCH associated with the transmitted PDSCH or by using a MAC CE message; reporting the second information by means of backscattering.

Embodiments of the present disclosure provides a method performed by a node in a wireless communication system, which includes: transmitting a first signal to a user equipment (UE), wherein the first signal includes a trigger signal for triggering the UE to perform reporting or a signal for power supply; and receiving second information from the UE when a third condition is met; wherein the third condition includes: energy of the second information or a backscattered first signal is greater than a third threshold.

According to embodiments of the present disclosure, wherein the second information includes at least one of: identification (ID) of the UE and/or a UE group, power information of the UE, data of the UE and measurement results.

According to embodiments of the present disclosure, the method further includes transmitting a second signal to the UE if the third condition is not met.

According to embodiments of the present disclosure, the method further includes determining configuration information of the second signal, wherein determining the configuration information of the second signal includes at least one of: receiving UE capability from the UE, and determining the configuration information of the second signal based on the UE capability; receiving a data size to be reported from the UE, and determining the configuration information of the second signal based on the data size to be reported; binding the frequency domain resource location of the second signal with an absolute radio frequency channel number (ARFCN); mapping the second signal to an out-band frequency domain resource.

Embodiments of the present disclosure provide a user equipment (UE) in a wireless communication system, including a transceiver configured to transmit and receive signals; and a controller coupled to the transceiver and configured to perform methods performed by a user equipment (UE) in a wireless communication system according to embodiments of the present disclosure.

Embodiments of the present disclosure provide a node in a wireless communication system, including a transceiver configured to transmit and receive signals; and a controller coupled to the transceiver and configured to perform methods performed by a node in a wireless communication system according to embodiments of the present disclosure.

Embodiments of the present disclosure provide a computer-readable medium having stored thereon computer-readable instructions which, when executed by a processor, are used to implement method performed by a user equipment (UE) and/or a node in a wireless communication system according to embodiments of the present disclosure.

Embodiments of the present disclosure can specify how to configure and monitor a trigger signal and/or a power-supply signal and how to report information such as data and/or power and the like (for example, specify the resource location or reporting conditions for data reporting, etc.) in a communication scenario involving an ambient power enabled IoT device or a passive IoT device.

### BRIEF DESCRIPTION OF DRAWINGS

The above and other aspects, features and advantages of certain embodiments of the present disclosure will be more apparent from the following description taken in conjunction with the accompanying drawings, in which:

FIG. 1 illustrates an example wireless network according to various embodiments of the present disclosure.

FIGS. 2A and 2B illustrate example wireless transmission and reception paths according to the present disclosure.

FIG. 3A illustrates an example UE according to the present disclosure.

FIG. 3B illustrates an example gNB according to the present disclosure.

FIG. 4 illustrates a flowchart of a method performed by a user equipment in a wireless communication system according to embodiments of the present disclosure.

FIG. 5 illustrates a flowchart of a method performed by a node in a wireless communication system according to embodiments of the present disclosure.

FIG. 6 illustrates a schematic diagram of a user equipment in a wireless communication system according to embodiments of the present disclosure.

FIG. 7 illustrates a schematic diagram of a node in a wireless communication system according to embodiments of the present disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

Technical schemes of embodiments of the present application can be applied to various communication systems, such as the Global System for Mobile Communications (GSM) system, code division multiple access (CDMA) system, wideband code division multiple access (WCDMA) system, general packet radio service (GPRS), long term evolution (LTE) system, LTE frequency division duplex (FDD) system, LTE time division duplex (TDD), universal mobile telecommunication system (UMTS), worldwide interoperability for microwave access (WiMAX) communication system, 5th generation (5G) system or new radio (NR), etc. In addition, technical schemes of embodiments of the present application can be applied to future-oriented communication technologies.

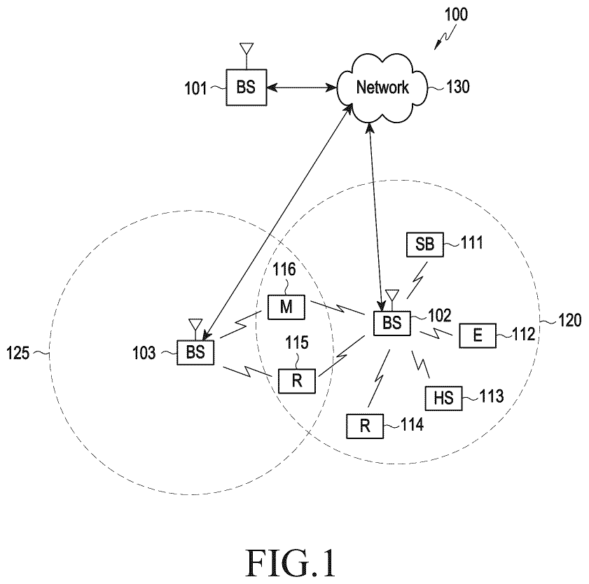

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E), a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

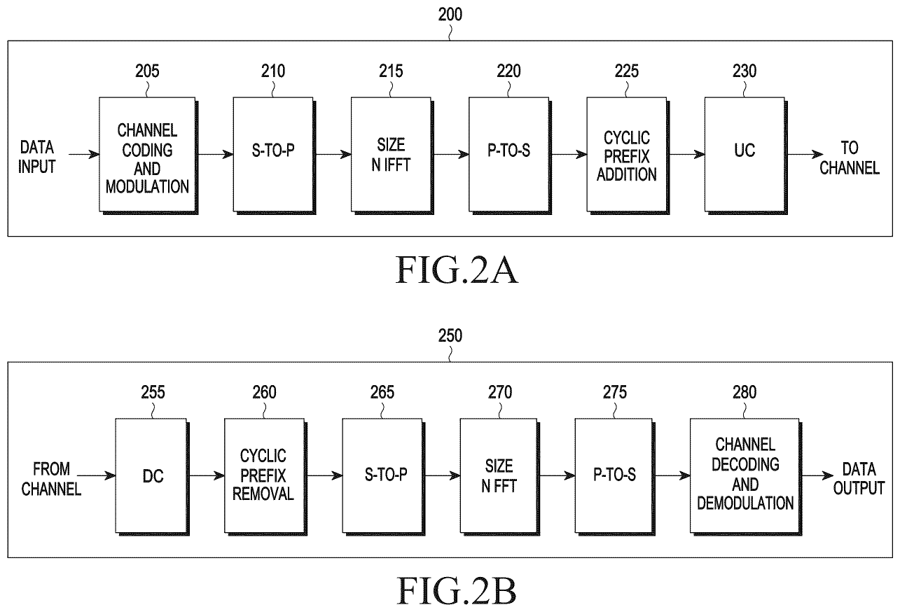

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal may also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGSs. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

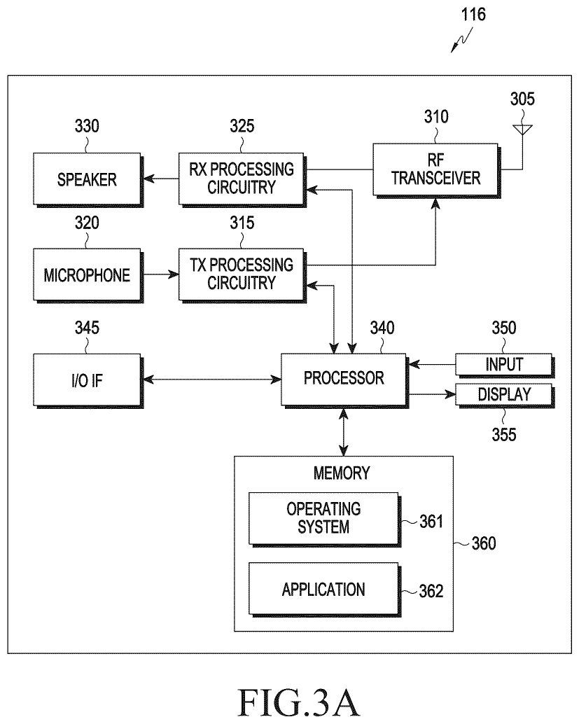

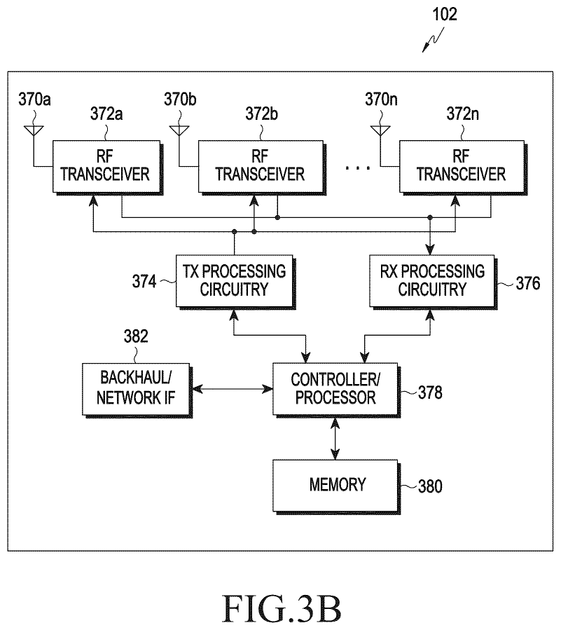

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370 a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal, RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

A time domain unit (also called time unit) in this application may be: an OFDM symbol, an OFDM symbol group (composed of multiple OFDM symbols), a slot, a slot group (composed of multiple slots), a subframe, a subframe group (composed of multiple subframes), a system frame and a system frame group (composed of multiple system frames); and it may also be an absolute time unit, such as 1 millisecond, 1 second, etc. A time unit may also be a combination of multiple granularities, such as NI slots plus N2 OFDM symbols.

A frequency domain unit (also called frequency unit) in this application may be: a subcarrier, a subcarrier group (composed of multiple subcarriers), a resource block (RB), which may also be called a physical resource block (PRB), a resource block group (composed of multiple RBs), a bandwidth part (BWP), a BWP group (composed of multiple BWPs), a frequency band/carrier, a frequency band/carrier group; and it may also be an absolute frequency domain unit, such as 1 Hz, 1 kHz, etc. A frequency domain unit may also be a combination of multiple granularities, such as MI PRBs plus M2 subcarriers.

The exemplary embodiments of the present disclosure are further described below in conjunction with the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

Transmission link of a wireless communication system mainly includes: a downlink from a base station such as a 5G New Radio (NR) gNB to a User Equipment (UE), an uplink from a UE to a base station, and a sidelink (SL) from a UE to a UE, which may also be called a sidelink, etc.

In some special scenes, such as an Internet of Things (IoT) scene, in order to further reduce energy consumption of the terminal side and reduce the deployment cost of devices, ambient power enabled IoT (A-IoT) devices or Passive IoT (P-IoT) devices are proposed to realize wireless communication with lower hardware complexity and lower power consumption. A-IoT or P-IoT converts received energy into AC or DC voltage by receiving peripheral RF signals and/or collecting energy from solar energy, vibration, thermal energy, wind energy and other energy sources, for example, converting RF signals into DC signals through an RF-DC converter, and then transmitting these electric energy to energy storage devices such as rechargeable batteries or capacitors for establishing wireless communication links. At this time, configuration and/or monitoring or receiving of a trigger signal and/or a power-supply signal, and/or behavior of a UE after receiving the trigger signal and/or the power-supply signal is a problem to be solved. For example, how to configure the trigger signal and/or the power-supply signal is a problem to be solved, and how to determine configuration parameters of the trigger signal and/or the power-supply signal and ways to generate the signals is a problem to be solved. For another example, how to monitor or receive the trigger signal and/or the power-supply signal is a problem to be solved. For another example, how to report data and/or information such as power is a problem to be solved. For example, how to determine the resource location and conditions for the UE to report data is a problem to be solved.

Specifically, in the present disclosure, a method and device for configuring and monitoring a trigger signal are provided. In embodiments of the present disclosure, a method for determining configuration parameters of a trigger signal, a method for monitoring the trigger signal, and a method for reporting data, power and other information are disclosed. In the present disclosure, exemplary methods are described by using a trigger signal as a non-limiting example of a signal for triggering UE to perform data reporting and using a power-supply signal as a non-limiting example of a signal for providing RF energy for UE. The described methods may also be used for receiving other signals and/or channels (for example, a physical downlink shared channel (PDSCH), and/or a physical downlink control channel (PDCCH), and/or a physical broadcast channel (PBCH), and/or a channel state information reference signal (CSI-RS), and/or a demodulation reference signal (DMRS)) in an IoT scene or other scenes.

In this embodiment, exemplary description is performed by using a tag as an ambient power enabled IoT device, where the tag may have different UE capabilities or device types, which is semi-statically indicated by a System Information Block (SIB) message or a Radio Resouce Control (RRC) message. The different UE capabilities or device types may include a combination of one or more of the following:

Fully passive (or passive) mode or device. A device of this type has no energy storage capability, cannot receive power-supply signals and cannot generate signals independently, but can transmit data to a base station by receiving and backscattering the first signal ;

Semi-passive mode or device, which, for example, transmitting data to the base station by receiving and backscattering the first signal. Optionally, this mode or device has an energy storage capability, can receive power-supply signals to charge the device, and cannot generate signals independently, but can amplify signals while backscattering the signals;

Active (or activated) mode or device, which, for example, can actively initiate communication by receiving the first signal and/or energy from other energy sources. This mode or device has an energy storage capability, can receive power-supply signals to charge the device, can independently generate signals and initiate data transmission. The other energy sources include but are not limited to at least one of the following: solar energy, vibration, thermal energy and wind energy. Among them, an active (or activated) mode or device may also be considered as a special case of semi-passive mode or device.

The first signal may be a trigger signal for triggering a tag to perform data reporting and/or a signal for synchronization such as SSB or a newly defined synchronization signal for replacing SSB function. Additionally or alternatively, in some implementations, the first signal may also include a power-supply signal for power supply to the UE.

A tag or tag group can directly perform transmission of a UL/DL signal and/or channel or a SL signal and/or channel with a reader, or establish a communication link with the reader by means of forwarding with a first node being used as a relay node, which can further expand the coverage of the signal and/or channel. The first node may be a UE or an Integrated Access Backhaul (IAB) or a Repeater or a Reconfigurable Intelligent Surface (RIS). The initiator of the first signal may be a base station or a UE supporting SL transmission or a first node used as a relay node, and the method for determining configuration parameters of the first signal may include a combination of one or more of the following:

The tag obtains configuration information of the first signal semi-statically by receiving a radio resource control (RRC) message or a media access control (MAC) control element (CE) message. Optionally, by establishing a one-to-one relationship between the domain of a HARQ process and a configuration index of the first signal, the tag can reuse the domain of the HARQ process for activating the associated configuration index of the first signal. Optionally, in order to increase the flexibility of tag charging and/or a chance of being triggered, the granularity of resource allocation period may be at an OFDM-symbol level;

The tag obtains configured configuration information of the first signal statically by receiving a radio resource control (RRC) message or a media access control (MAC) control element (CE) message;

The tag obtains configuration information of the first signal dynamically by receiving downlink control information (DCI). The downlink control information (DCI) may include at least one of the following:

The tag obtains the configuration information of the first signal by receiving a newly defined DCI format, which may include at least one of the following: 1-bit identifier for DCI formats, frequency domain resource assignment (FDRA) (the bit number of the FDRA is calculated according to the configuration of the first signal), 4-bit time domain resource assignment (TDRA), 2-bit Downlink assignment index, 2-bit TPC command for scheduled PUCCH, 3-bit PUCCH resource indicator, 3-bit PDSCH-to-HARQ feedback timing indicator, and first signal power spectral density indicator; in the present disclosure, the above specific number of bits is only an example, and the present disclosure can also use any other specific field of bit number;

The tag obtains the configuration information of the first signal by receiving TDRA and/or FDRA in DCI format 1_0 and/or DCI format 1_1 and/or DCI format 1_2;

The configuration information of the first signal may include at least one of the following: the subcarrier spacing of the first signal, the starting PRB index of the first signal, the number of PRBs occupied by the first signal, the port of the first signal, the transmission period and/or offset of the first signal, and the time-domain starting point and/or duration of the first signal;

The first signal may be mapped to OFDM symbols by single-carrier or multi-carrier time-frequency resource mapping, and in order to reduce the power loss at the tag, the first signal may be modulated by amplitude shift keying (ASK) and/or frequency shift keying (FSK) in the time domain. Herein the single-carrier resource mapping can improve the signal energy received at the tag;

The first signal may be generated by a (pre-)defined physical signal sequence, and optionally, the physical signal sequence may be a ZC sequence, or an M sequence, or a Gold sequence, or a PN sequence;

Optionally, when a tag or a tag group establishes a UL/DL/SL communication link through a forwarding mode, the base station semi-statically configures a first signal for the tag, and the first node as a relay node obtains the configuration information of the first signal by receiving a radio resource control (RRC) message or a media access control (MAC) control element (CE) message, and transmits the first signal to the tag according to the received configuration information.

The tag may report one or more supported UE capabilities or device types to a reader. Depending on the indicated UE capabilities or device types, the method of monitoring and/or detecting and/or receiving the first signal may include one or more of the following:

The tag monitors and/or detects and/or receives the first signal on a transmission resource semi-statically configured for the first signal activated by DCI.

Optionally, the tag may monitor and/or detect and/or receive the first signal at a semi-statically configured PDSCH occasion,

The tag periodically monitors and/or detects and/or receives the first signal on a configured transmission resource for the first signal;

The tag monitors and/or detects and/or receives the first signal dynamically indicated by downlink control information (DCI);

The tag may monitor and/or detect and/or receive the first signal (only) in a number of predefined time units before data reporting, that is, the starting location of monitoring and/or detecting and/or receiving of the first signal is determined by a starting location of data reporting and a pre-configured offset, which is a predefined parameter value or a parameter value (pre-) configured by the base station. The duration of monitoring and/or detecting and/or receiving of the first signal may also be a predefined parameter value or a (pre-) configured parameter value by the base station;

The tag or tag group may monitor and/or detect and/or receive the first signal (only) in a configured first window. Optionally, the tag or tag group monitors and/or detects and/or receives the first signal (only) in the activated first window;

The reader may be a base station and/or a UE supporting sidelink transmission;

Activation and/or deactivation of the first window may be performed through a sidelink control information (SCI) signaling or DCI signaling or radio resource control (RRC) message or media access control (MAC) control element (CE) message. The configuration method of the first window may include one or more of the following:

The first information of the first window is configured separately, and the base station uses system information, such as SIBI, to indicate the first information of the currently configured first window for configuring a cell-specific first window. The tag obtains first information of the cell-specific first window by receiving a SIB1 message;

The tag semi-statically obtains the first information of the first window by receiving the radio resource control (RRC) message or the media access control (MAC) control element (CE) message, which is used to determine the specific first window of the tag or tag group.

The first information may include at least one of the following: a period of the first window, a starting location of the first window, a duration of the first window, and a bandwidth of the first window, where the starting location of the first window is a starting time unit of the first window;

Optionally, the tag or tag group may be configured with a first window (only) in a discontinuous reception (DRX) active state or a DRX ON period. For example, the period of the first window is configured according to the period of DRX ON, for example, it is consistent with the period of DRX ON, that is, it is equal to the period of DRX ON;

Optionally, the period of the first window is configured according to a period of a paging occasion (PO), for example, it is consistent with the period of PO, that is, it is equal to the period of PO;

Optionally, the starting location of the first window is determined by the starting location of DRX or PO and a predefined or preconfigured offset;

Optionally, the first window period is configured by the core network;

After the tag receives the first signal, if a first condition is not met, the behavior of the tag may include one or more of the following:

After receiving the first signal and/or a DCI scheduling the first signal, the tag may feed back a NACK signal to the reader to indicate that the power of the tag cannot support uplink data transmission, or define a new UCI format, using 1-bit to feed back a “low power” alarm of the tag;

The tag monitors and/or detects and/or receives the power-supply signal (only) in DRX active state or DRX ON period. Optionally, when the tag receives DCI information scheduling the power-supply signal, the DRX inactive timer (drx-InactivityTimer) is not enabled, and/or the first timer is enabled, which is used to prolong the time that the tag is in DRX active state or DRX ON period. The first timer indicates the duration for the tag to monitor the DCI which is used to schedule the power-supply signal, and represents the number of units or duration of continuous PDCCHs in the DRX active state or a DRX ON period after the tag decodes a DCI which is used to indicate to start receiving the power-supply signal, optionally, it may represents the number of subframes of continuous PDCCHs in DRX active state or DRX ON period after the tag decodes a DCI which is used to indicate to start receiving the power-supply signal;

The tag (only) starts the first timer, (only) monitors the PDCCH which is used to schedule the power-supply signal in DRX active state or DRX ON period, and/or does not start a DRX inactive timer (drx-Inactivity Timer);

The tag (only) starts the first timer, (only) monitors the PDCCH which is used to schedule the power-supply signal in DRX active state or DRX ON period, and/or does not monitor or receive the PDCCH which is used to schedule other signals except the power-supply signal and/or the wake-up signal, for example, does not monitor or receive a PDCCH which is used to schedule paging message and/or wake-up signal;

The first condition may include a combination of one or more of the following:

The energy (e.g., received signal strength, received signal reference power (RSRP), etc.) of the first signal received by the tag or tag group is greater than (or greater than or equal to) a first threshold;

The power information of the tag is greater than (or greater than or equal to) a second threshold;

The energy (e.g., received signal strength, received signal reference power (RSRP), etc.) of the second information or the backscattered first signal detected by a reader is greater than (or greater than or equal to) a third threshold;

The first threshold and/or the second threshold and/or the third threshold may be parameter values determined by the user equipment (UE) according to its own processing capability, and/or parameter values configured by the base station (for example, parameter values configured by the base station received by the UE), and/or pre-configured parameter values. Herein, the first threshold and/or the second threshold and/or the third threshold may be real numbers greater than 0.

The second information may include at least one of the following: tag (and/or tag group) ID, tag power, local data (for example, some specific local data in the tag), and collected measurement data/results (for example, location, temperature, etc.);

The configuration method of the power-supply signal may include one or more of the following:

According to the UE capability or device type, if the tag is in semi-passive mode or is a semi-passive device or is in an active (or activated) mode or is an active device, or the tag has an energy storage capability and can charge the device by receiving power-supply signals, the reader determines configuration parameters of the power-supply signal according to the method for determining the configuration parameters of the first signal, and/or monitors and/or detects and/or receives the power-supply signal according to the method for monitoring and/or detecting and/or receiving the first signal;

Configure a duration and/or period for monitoring the power-supply signal according to the UE capability or device type. Optionally, the UE capability or device type of a tag may correspond to one or more predefined or (pre-) configured durations of power-supply signals. Optionally, the UE capability or device type of a tag may correspond to one or more predefined or (pre-) configured transmission periods of power-supply signals.

The tag reports the bit number of local data to be reported and/or the bit number of collected measurement data/results through a PUCCH or PUSCH or RRC message or MAC CE message, and the reader calculates the power corresponding to the transmission bits according to the reported bit number of the local data and/or bit number of collected measurement data/results, and configures the duration or period of the power-supply signal according to the calculated power information;

The frequency domain resource location of the power-supply signal may be bound with an absolute radio frequency channel number (ARFCN), and the base station can broadcast a frequency band supporting the transmission of the power-supply signal to the tag; and/or the tag reports the supported one or more frequency locations or frequency bands for receiving the power-supply signal to the base station, and the base station selects one of the reported frequency locations or frequency bands to transmit the power-supply signal; and/or the tag binds a specific frequency location or frequency band information for receiving the power-supply signal through one-time registration information, such as the NAS ID (corresponding to one unique UE ID) or I-RNTI of the UE when connecting to the base station; and/or it may be obtained by a Point A calculated by a SSB subcarrier offset and an offset to Point A (OffsetToPointA) which is carried by a main information block (MIB) and a predefined or preconfigured offset, where the granularity of the predefined or preconfigured offset may be a subcarrier or a physical resource block (PRB);

In order to normally receive the power-supply signal to re-establish a network connection when the tag loses the network connection, and/or reduce the interference between the received power-supply signal and the transmission of a DL and/or UL/or SL signal and/or channel and/or a backscattered signal, the power-supply signal may be mapped to out-band frequency domain resources, that is, the tag may perform energy collection on out-band frequency domain resources. The out-band frequency domain resource refers to a frequency domain location or frequency band where no communication signal is transmitted, for example, it may be a frequency band where the guard interval and/or the centre frequency are located.

After receiving the first signal, the tag may report second information to the reader if the first condition is met. Optionally, the tag may start a DRX inactive timer (drx-Inactivity Timer) to monitor the PDCCH which is used to schedule other signals except the power-supply signal in a DRX active state or DRX ON period. The method for reporting or feeding back the second information by the tag may include one or more of the following:

The tag obtains time-frequency resources used for data reporting semi-statically by receiving a radio resource control (RRC) message or media access control (MAC) control element (CE) message. Optionally, the tag reports or feeds back the second information by a configured grant type 2 PUSCH or a grant-free PUSCH;

The tag reports or feeds back the second information on time-frequency resources indicated by TDRA and/or FDRA in a received DCI format 0_0 or DCI format 0_1 or DCI format 0_2. The number of bits of FDRA is determined according to the size of the uplink BWP. Optionally, the TDRA table for reporting or feeding back the second information is determined according to the RNTI used in the scrambling process of the PDCCH corresponding to the received DCI and the search space;

The tag reports or feeds back the second information by using a dynamically scheduled PUSCH on the time-frequency resources indicated by TDRA and/or FDRA in the DCI format 0_0 and/or DCI format 0_1 and/or DCI format 0_2;

The second information is reported or fed back periodically on configured time-frequency resources. At this time, the period of data reporting may be semi-statically configured by the base station through a radio resource control (RRC) message or media access control (MAC) control element (CE) message or high-level signaling.

The tag configures the period of data reporting according to the DTX period, for example, the period of data reporting may be equal to the DIX period. Optionally, the tag reports data information in DRX active state or DRX ON period;

When the tag obtains the configuration information of the first signal by receiving DCI format 1_0 and/or DCI format 1_1 and/or DCI format 1_2, it reports or feeds back the second information by using a PUCCH associated with the DCI;

After receiving the first signal transmitted by a reader, the tag reports the second information (including data information, for example) through a first grant-free PUSCH or in the next data reporting period;

After receiving the first signal transmitted by a reader, the tag performs reporting of the second information (for example, data reporting) once or periodically within a predefined or preconfigured period of time. Optionally, the tag transmits a data reporting request, and after receiving the first signal, the tag performs reporting of the second information (for example, data reporting) once or periodically within a predefined or preconfigured period of time.

After receiving the first signal transmitted by a reader, the tag transmits indication information of whether data reporting is needed. Optionally, the tag may transmit the indication information of whether data reporting is needed through a UCI or PUSCH. Optionally, the indication information may be transmitted by using 1 bit. Optionally, when the tag detects the collected local data changes, after receiving the first signal transmitted by a reader, the tag transmits the indication information that data reporting needs to be performed. When the reader receives the indication information that the tag needs to report data, it transmits downlink scheduling grant information to trigger the tag to report the second information once or periodically (for example, data reporting) on a PUSCH;

When the tag detects the first signal at a PDSCH occasion of semi-static transmission, it reports or feeds back the second information on a PUCCH associated with the PDSCH of semi-static transmission or by using a MAC CE message;

The tag may report data by means of backscattering. The backscattering may modulate the first signal by amplitude shift keying (ASK) and/or frequency shift keying (FSK) and/or phase shift keying (PSK) to carry the reported data information.

The second information may include at least one of the following: tag (and/or tag group) ID, tag power, local data, and collected measurement results.

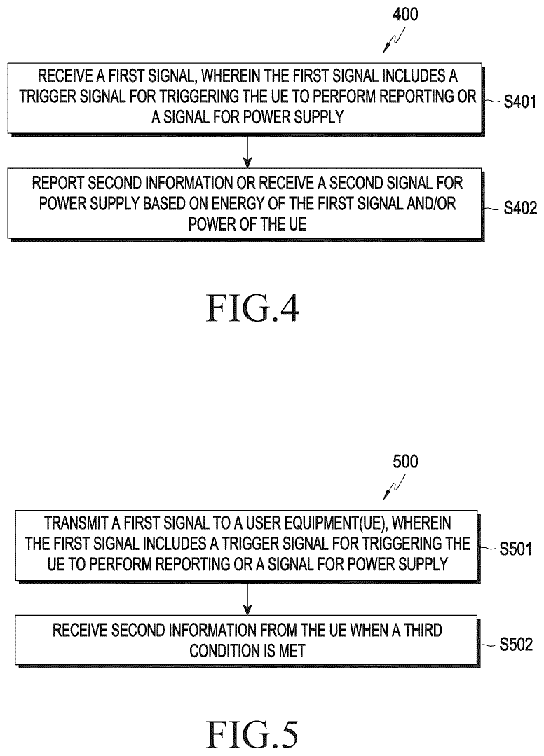

Next, FIG. 4 illustrates a flowchart of a method 400 performed by a user equipment in a wireless communication system according to embodiments of the present disclosure.

As shown in FIG. 4, in step S401, a UE (e.g., a tag) may obtain and/or receive a first signal. For example, the tag may obtain and/or receive a first signal from a base station or another UE. In some implementations, the first signal may include a trigger signal for triggering the UE to perform reporting and/or a power-supply signal for power supply to the UE. In step S402, the UE may report second information or receive a second signal for power supply based on energy of the first signal and/or power of the UE.

According to embodiments of the present disclosure, reporting second information or receiving a second signal for power supply based on energy of the first signal and/or power of the UE includes: when the energy of the first signal meets a first condition and/or the power of the UE meets a second condition, reporting the second information; and/or when the energy of the first signal does not meet the first condition and/or the power of the UE does not meet the second condition, receiving the second signal for power supply; wherein the first condition includes that the energy of the first signal is greater than a first threshold; the second condition includes that the power of the UE is greater than a second threshold.

According to embodiments of the present disclosure, wherein the second information includes at least one of: identification (ID) of the UE and/or a UE group, power information of the UE, data of the UE and measurement results.

According to embodiments of the present disclosure, the method further includes receiving configuration information of the first signal, wherein the configuration information of the first signal includes at least one of the following: subcarrier spacing of the first signal, starting physical resource block (PRB) index of the first signal, number of occupied PRBs of the first signal, port of the first signal, transmission period and/or offset of the first signal, and time-domain starting point and/or duration of the first signal.

According to embodiments of the present disclosure, receiving the configuration information of the first signal includes at least one of: obtaining the configuration information of the first signal by receiving a radio resource control (RRC) message or a media access control (MAC) control element (CE) message; obtaining the configuration information of the first signal by receiving downlink control information (DCI).

According to embodiments of the present disclosure, receiving a first signal includes monitoring and/or receiving the first signal based on the configuration information, wherein monitoring and/or receiving the first signal based on the configuration information includes at least one of: monitoring and/or receiving the first signal on a configured transmission resource for the first signal activated by downlink control information (DCI); monitoring and/or receiving the first signal at a physical downlink shared channel (PDSCH) occasion; periodically monitoring and/or receiving the first signal on a configured transmission resource for the first signal; monitoring and/or receiving a first signal indicated by downlink control information (DCI); monitoring and/or receiving the first signal in a number of predefined time units before data reporting; monitoring and/or receiving the first signal within a configured first window.

According to embodiments of the present disclosure, configuration of the first window includes at least one of: receiving first information of the configured first window from a node; obtaining first information of the first window by receiving a radio resource control (RRC) message or a media access control (MAC) control element (CE) message; wherein the first information includes at least one of the following: a period of the first window, a starting location of the first window, a duration of the first window and a bandwidth of the first window, wherein the starting location of the first window is a starting time unit of the first window.

According to embodiments of the present disclosure, the period of the first window is configured according to at least one of the following: configuring the period of the first window according to a period of a discontinuous reception active state; configuring the period of the first window according to a period of a paging occasion (PO); configuring the period of the first window by a core network.

According to embodiments of the present disclosure, when the energy of the first signal does not meet the first condition and/or the power of the UE does not meet the second condition, receiving the second signal for power supply includes performing at least one of the following: receiving the second signal during a discontinuous reception (DRX) active state; starting a first timer, monitoring a physical downlink control channel (PDCCH) scheduling the second signal during a DRX active state, and/or not starting a DRX inactive timer; starting a first timer, monitoring a physical downlink control channel (PDCCH) scheduling the second signal during a DRX active state, and/or not monitoring or receiving a PDCCH scheduling for other signals except the second signal and/or a wake-up signal.

According to embodiments of the present disclosure, the method further includes: when the energy of the first signal does not meet the first condition and/or the power of the UE does not meet the second condition, transmitting a negative acknowledgement (NACK) signal or a new uplink control information (UCI) format to a node.

According to embodiments of the present disclosure, the method further includes: transmitting UE capability to a node; and receiving configuration information of the second signal from the node, wherein the configuration information of the second signal is determined by the node based on the UE capability.

According to embodiments of the present disclosure, the method further includes: transmitting a data size to be reported to the node; and receiving configuration information of the second signal from the node, wherein the configuration information of the second signal is determined by the node based on the data size to be reported.

According to embodiments of the present disclosure, reporting the second information includes performing at least one of the following: obtaining time-frequency resources for data reporting by receiving a radio resource control (RRC) message or a media access control (MAC) control element (CE) message, and reporting the second information on the time-frequency resources; reporting the second information on time-frequency resources indicated by time domain resource assignment (TDRA) and/or frequency domain resource assignment (FDRA)in received downlink control information (DCI) format 0_0 or DCI format 0_1 or DCI format 0_2; reporting the second information using a scheduled physical uplink shared channel (PUSCH) on time-frequency resources indicated by TDRA and/or FDRA in DCI format 0_0 and/or DCI format 0_1 and/or DCI format 0_2; periodically reporting the second information on configured time-frequency resources; when the UE obtains the configuration information of the first signal by receiving DCI format 1_0 and/or DCI format 1_1 and/or DCI format 1_2, reporting the second information using a physical uplink control channel (PUCCH) associated with the DCI; after receiving the first signal, reporting the second information through the first grant-free PUSCH or in the next data reporting period; after receiving the first signal, reporting the second information once or periodically within a predefined time period; receiving downlink scheduling grant information to trigger the UE to report the second information once or periodically on a PUSCH; when the UE detects the first signal at a transmitted PDSCH occasion, reporting the second information on a PUCCH associated with the transmitted PDSCH or by using a MAC CE message; reporting the second information by means of backscattering.

FIG. 5 illustrates a flowchart of a method 500 performed by a node in a wireless communication system according to embodiments of the present disclosure.

As shown in FIG. 5, in step S501, a node (e.g., a base station or another UE) may transmit a first signal to a user equipment (UE) (e.g., a tag). In some implementations, the first signal may include a trigger signal for triggering the UE to perform reporting and/or a power-supply signal for power supply to the UE. In step S502, the node may receive second information from the UE when a third condition is met. In some implementations, the third condition may include that energy of the second information or a backscattered first signal is greater than a third threshold.

According to embodiments of the present disclosure, wherein the second information includes at least one of: identification (ID) of the UE and/or a UE group, power information of the UE, data of the UE and measurement results.

According to embodiments of the present disclosure, the method further includes transmitting a second signal to the UE if the third condition is not met.

According to embodiments of the present disclosure, the method further includes determining configuration information of the second signal, wherein determining the configuration information of the second signal includes at least one of: receiving UE capability from the UE, and determining the configuration information of the second signal based on the UE capability; receiving a data size to be reported from the UE, and determining the configuration information of the second signal based on the data size to be reported; binding the frequency domain resource location of the second signal with an absolute radio frequency channel number (ARFCN); mapping the second signal to an out-band frequency domain resource.

It should be understood that the methods 400 and 500 according to embodiments of the present disclosure may also include any combination of any method or step as described above in connection with embodiments of the present disclosure.

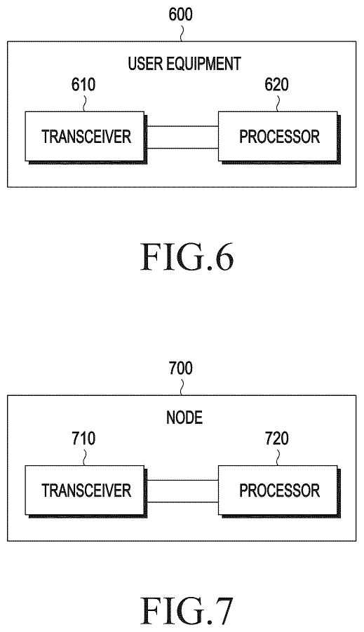

Next, FIG. 6 illustrates a schematic diagram of a user equipment 600 in a wireless communication system according to embodiments of the present disclosure.

As shown in FIG. 6, a user equipment 600 (e.g., a tag) according to embodiments of the present disclosure may include a transceiver 610 and a processor 620. The transceiver 610 may be configured to transmit and receive signals. The processor 620 may be coupled to the transceiver 610 and may be configured to (e.g., control the transceiver 610 to) perform any method performed by a user equipment in a wireless communication system according to embodiments of the present disclosure.

FIG. 7 illustrates a schematic diagram of a node 700 in a wireless communication system according to embodiments of the present disclosure.

As shown in FIG. 7, a node 700 (e.g., a base station or another UE) according to embodiments of the present disclosure may include a transceiver 710 and a processor 720. The transceiver 710 may be configured to transmit and receive signals. The processor 720 may be coupled with the transceiver 710 and may be configured to (e.g., control the transceiver 710 to) perform any method performed by a node according to embodiments of the present disclosure. Herein, a processor may also be called a controller.

Various embodiments of the present disclosure may be implemented as computer-readable codes embodied on a computer-readable recording medium from a specific perspective. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (e.g., data transmission via the Internet), etc. Computer-readable recording media may be distributed by computer systems connected via a network, and thus computer-readable codes may be stored and executed in a distributed manner. Furthermore, functional programs, codes and code segments for implementing various embodiments of the present disclosure may be easily explained by those skilled in the art to which the embodiments of the present disclosure are applied.

It will be understood that the embodiments of the present disclosure may be implemented in the form of hardware, software, or a combination of hardware and software. The software may be stored as program instructions or computer-readable codes executable on a processor on a non-transitory computer-readable medium. Examples of non-transitory computer-readable recording media include magnetic storage media (such as ROM, floppy disk, hard disk, etc.) and optical recording media (such as CD-ROM, digital video disk (DVD), etc.). Non-transitory computer-readable recording media may also be distributed on computer systems coupled to a network, so that computer-readable codes are stored and executed in a distributed manner. The medium may be read by a computer, stored in a memory, and executed by a processor. Various embodiments may be implemented by a computer or a portable terminal including a controller and a memory, and the memory may be an example of a non-Substitute transitory computer-readable recording medium suitable for storing program(s) with instructions for implementing embodiments of the present disclosure. The present disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the present disclosure suitably includes its equivalents.

What has been described above is only the specific implementation of the present disclosure, but the scope of protection of the present disclosure is not limited thereto. Anyone who is familiar with this technical field may make various changes or substitutions within the technical scope disclosed in the present disclosure, and these changes or substitutions should be covered within the scope of protection of the present disclosure. Therefore, the scope of protection of the present disclosure should be based on the scope of protection of the claims.

1. A method performed by a user equipment (UE) in a wireless communication system, including:
receiving, from a network node, a first signal including a trigger signal for triggering the UE to perform reporting or a signal for power supply; and
reporting first information or receiving a second signal for the power supply based on energy of at least one of the first signal or power of the UE.

2. The method of claim 1, wherein reporting the first information or receiving the second signal for the power supply based on the energy of at least one of the first signal or the power of the UE includes:
in case at least one of that the energy of the first signal meets a first condition or that the power of the UE meets a second condition, reporting the second information; or
in case at least one of that the energy of the first signal does not meet the first condition or the power of the UE does not meet the second condition, receiving the second signal for power supply;
wherein the first condition includes that the energy of the first signal is greater than a first threshold, and
wherein the second condition includes that the power of the UE is greater than a second threshold.

3. The method of claim 1, wherein the first information includes at least one of: identification (ID) of at least one of the UE or a UE group, power information of the UE, data of the UE and measurement results.

4. The method of claim 2, wherein in case at least one of that the energy of the first signal does not meet the first condition or that the power of the UE does not meet the second condition, receiving the second signal for the power supply includes performing at least one of the following:
receiving the second signal during a discontinuous reception (DRX) active state;
starting a first timer, monitoring a physical downlink control channel (PDCCH) scheduling the second signal during a DRX active state, or not starting a DRX inactive timer; and
starting a first timer, monitoring a physical downlink control channel (PDCCH) scheduling the second signal during a DRX active state, or not monitoring or receiving a PDCCH scheduling for other signals except the second signal or a wake-up signal.

5. The method of claim 2, further including:
in case that the energy of the first signal does not meet the first condition or the power of the UE does not meet the second condition, transmitting a negative acknowledgement (NACK) signal or a new uplink control information (UCI) format to a node.

6. The method of claim 1, further including:
transmitting, to the network node, UE capability; and
receiving, from the network node, configuration information of the second signal, wherein the configuration information of the second signal is determined based on the UE capability.

7. The method of claim 1, further including:
transmitting, to the network node, a data size to be reported; and
receiving, from the network node, configuration information of the second signal, wherein the configuration information of the second signal is determined based on the data size to be reported.

8. A method performed by a network node in a wireless communication system, comprising:
transmitting, to a user equipment (UE), a first signal including a trigger signal for triggering the UE to perform reporting or a signal for power supply; and
receiving, from the UE, first information, in case that a third condition is met;
wherein the third condition includes: energy of the second information or a backscattered first signal is greater than a third threshold.

9. The method of claim 8, wherein the first information includes at least one of: identification (ID) of the UE or a UE group, power information of the UE, data of the UE and measurement results.

10. The method of claim 8, further including:
transmitting a second signal to the UE if the third condition is not met.

11. The method of claim 10, further including determining configuration information of the second signal,
wherein determining the configuration information of the second signal includes at least one of:
receiving UE capability from the UE, and determining the con-figuration information of the second signal based on the UE capability;
receiving second information about a data size to be reported from the UE, and determining the configuration information of the second signal based on the second information about the data size to be reported;
binding the frequency domain resource location of the second signal with an absolute radio frequency channel number (ARFCN); or
mapping the second signal to an out-band frequency domain resource.

12. A user equipment (UE) in a wireless communication system, the UE comprising:
a transceiver configured to transmit and receive signals; and
at least one processor coupled to the transceiver and configured to:
receive, from a network node, a first signal including a trigger signal for triggering the UE to perform reporting or a signal for power supply, and
report first information or receiving a second signal for the power supply based on energy of at least one of the first signal or power of the UE.

13. The UE of claim 12, wherein the at least one processor is further configured to:
in case at least one of that the energy of the first signal meets a first condition or that the power of the UE meets a second condition, report the second information, or
in case at least one of that the energy of the first signal does not meet the first condition or the power of the UE does not meet the second condition, receive the second signal for power supply;
wherein the first condition includes that the energy of the first signal is greater than a first threshold, and
wherein the second condition includes that the power of the UE is greater than a second threshold.

14. A network node in a wireless communication system, the network node comprising:
a transceiver configured to transmit and receive signals; and
at least one processor coupled to the transceiver and configured to:
transmit, to a user equipment (UE), a first signal including a trigger signal for triggering the UE to perform reporting or a signal for power supply, and
receive, from the UE, first information, in case that a third condition is met,
wherein the third condition includes: energy of the second information or a backscattered first signal is greater than a third threshold.

15. The network node of claim 14, wherein the second information includes at least one of: identification (ID) of the UE or a UE group, power information of the UE, data of the UE and measurement results.
